(19) United States
(12) Patent Application Publication
(10) Pub. No.: US 2010/0189888 A1
(43) Pub. Date: Jul. 29, 2010

(54) METHOD OF FORMING A COATING FILM ON THE SURFACE OF A PLASTIC LENS

(76) Inventor: Katsuhiro Mori, Yamaguchi (JP)

Correspondence Address: BIRCH STEWART KOLASCH & BIRCH, PO BOX 747, FALLS CHURCH, VA, 22040-0747, US

(21) Appl. No.: 12/667,992

(22) PCT Filed: Aug. 19, 2008
(86) PCT No.: PCT/JP2008/064739

§ 371 Date: Jan. 6, 2010

(30) Foreign Application Priority Data
Aug. 24, 2007 (JP) 2007-217811

(51) Int. Cl. B05D 5/06; G02B 1/10

(52) U.S. Cl. 427/162

(57) ABSTRACT

[Problem] To form a coating film without developing stripes by spin-coating relying on a simple control and using a coating solution in small amounts.

[Means for Solution] A coating film is formed by using an ejection device having a main ejection nozzle 7 and an auxiliary ejection nozzle 9, arranging the main ejection nozzle 7 and the auxiliary nozzle 9 over the convex surface 1a of the plastic lens 1 in a manner that the main ejection nozzle 7 is positioned over the center of the plastic lens 1, ejecting a coating solution containing a volatile organic solvent from the main ejection nozzle 7 and the auxiliary ejection nozzle 9, simultaneously, in a state where the lens 1 is maintained rotated, while linearly moving the main ejection nozzle 7 and the auxiliary ejection nozzle 9 in a direction in which they separate away from the center O of the lens yet maintaining constant a gap between these two nozzles, discontinuing the ejection of the coating solution from the main ejection nozzle 7 and the auxiliary ejection nozzle 9 at the time when the main ejection nozzle 7 is positioned on the edge of the lens 1, and drying a coating layer formed on the convex surface 1a of the lens 1.

### TECHNICAL FIELD

The present invention relates to a method of forming a coating film on the surface of a plastic lens and, more specifically, to a method of forming a coating film of a uniform thickness on a convex surface of a plastic lens having a degree of convexity of not smaller than 1.0 by spin coating.

### BACKGROUND ART

Plastic lenses have now been generally used as spectacle lenses since they can be formed easily, inexpensively and in large quantity. Various coating films have been formed on the surfaces of the plastic lenses depending upon their uses, such as a hard coating for preventing the surfaces of the lenses from being scratched, a photochromic layer which changes color upon the irradiation with light, and a primer layer for improving the close adhesion between the photochromic layer and the surface of the lens.

The spin-coating method is a well-known means for forming a coating layer on the surfaces of a base member. This method consists of ejecting a coating solution onto the surface of the revolving base member enabling the coating solution to be diffused from the central portion toward the circumferential edge portion by utilizing the centrifugal force to thereby form a thin and uniformly thick coating layer. The coating layer that is formed is, as required, dried or fired so as to be fixed to the surface of the base member. The above spin-coating method is also utilized for forming a coating film on the surfaces of plastic lenses.

When the coating is to be formed by the spin-coating, the solution is diffused by the centrifugal force. Therefore, the coating solution is required in an amount larger than that required by the spray-coating or brush-coating. This tendency becomes further conspicuous when various coating films are to be formed by spin-coating on the surfaces of plastic lenses. That is, since the lens has a convex surface, a large amount of coating solution falls down from the circumferential edge portion as compared to when a flat surface is to be coated. As a result, an excess of the coating solution must be used for forming the coating film having a desired thickness. This problem becomes considerably serious when a photochromic layer or a primer layer is to be formed on the surfaces of the plastic lenses. That is, the coating solution used for forming such a film contains a polymerizing component and, therefore, the coating solution that has flown down cannot be reused but must be discarded.

Many proposals have heretofore been made concerning means for forming a uniform and thin film on the surfaces of a base member by ejecting the coating solution in decreased amounts by spin-coating.

For example, patent document 1 proposes an apparatus for forming a thin film comprising means for rotating a base member on which a coating layer is to be formed; relatively moving means for moving an ink jet having a plurality of fine nozzles for ejecting a coating solution relative to the base member between a region near the rotary shaft and a region away from the rotary shaft; and relative movement control means for decreasing the relatively moving speed of the ink jet from the region near the rotary shaft toward the region away therefrom or for decreasing the rotational angle of the base member depending upon the relative movement of the ink jet.

Further, patent document 2 proposes a method which divides a base member on which a coating layer is to be formed into an inner region and an outer region, and increases the amount the coating solution is ejected from the ejection nozzle toward the outer region rather than on the inner region. This method uses an ejection nozzle having a plurality of ejection heads, and ejection amounts of the ejection heads are controlled depending upon the regions so as to adjust the amount the coating solution is ejected from the ejection nozzle.

Patent document 1: JP-A-9-10657

Patent document 2: JP-A-2004-47579

### DISCLOSURE OF THE INVENTION

### Problems to be Solved by the Invention

The methods proposed by the above patent documents 1 and 2 are capable of forming a coating film of a uniform thickness using a coating solution in decreased amounts, and are very advantageous for coating semiconductor substrates, liquid crystal display devices and substrates for color filters.

However, these methods require a very fine control, and the apparatuses therefor become complex and expensive. Namely, from the standpoint of cost, these methods are not practicable as means for forming a coating film on very inexpensive base members such as plastic lenses.

Further, the above methods can be utilized as means for coating flat surfaces of relatively large areas but cannot be industrially put into practice as means for coating portions of small areas having convex surfaces, such as the surfaces of plastic lenses. That is, the velocity of flow of the coating solution (velocity of flow in the radial direction) at the center of the convex surface (center of rotation) is greatly different from the velocity of flow of the coating solution (velocity of flow in the radial direction) at the circumferential edge portion of the convex surface on the portion of a small area. Therefore, a very complex control must be executed on a region of a small area, such as controlling the relatively moving speed of the ink jet and the angular speed of rotation of the base member, or dividing the surface (convex surface) of the base member and controlling the amount of ejection for each of the divided regions.

Further, when a thin film is formed on the surface of a plastic lens by spin-coating, linear stripes often develop in the circumferential edge portion along the radial direction of the lens. The stripes can be clearly recognized as shown in FIG. 4 if light is projected onto the lens and if the projected surface is observed. The stripes become thick toward the edge of the lens adversely affecting optical properties of the lens and, therefore, must be removed.

Almost no report has been made concerning the stripes. According to the study conducted by the present inventors, however, it was learned that the development of stripes becomes conspicuous with a decrease in the amount of ejecting the coating solution. At present, therefore, the development of stripes has been prevented by forming the coating by ejecting the coating solution in large amounts.

As described above, however, many of the coating solutions used for forming a coating film on the surfaces of plastic lenses cannot be reused. It is, therefore, necessary to prevent the occurrence of stripes while using the coating solution in amounts as small as possible.

It is, therefore, an object of the present invention to provide a method of forming a coating film without developing stripes based on very simple means by forming a coating film of a uniform thickness on the convex surface of a plastic lens by spin-coating without effecting complex control.

### Means for Solving the Problems

The present inventors have forwarded the study concerning the development of stripes, have discovered that the development of stripes is a phenomenon that specifically occurs when the convex surfaces are spin-coated with a coating solution that contains a volatile organic solvent having a boiling point of lower than 100° C. and that the stripes easily develop with an increase in the degree of convexity, and have completed the invention based on the above discovery.

That is, the present invention is concerned with a method of forming a coating film on a convex surface of a plastic lens having the convex surface of a degree of convexity defined by the following formula,

degree of convexity=100 (cm)/focal distance (cm)

of not smaller than 1.0, comprising:

using an ejection device having a main ejection nozzle and an auxiliary ejection nozzle;

arranging the main ejection nozzle and the auxiliary nozzle over the convex surface of the plastic lens in a manner that the main ejection nozzle is positioned over a center of the plastic lens;

ejecting a coating solution containing a volatile organic solvent having a boiling point of lower than 100° C. from the main ejection nozzle and the auxiliary ejection nozzle, simultaneously, in a state where the plastic lens is maintained rotated, while linearly moving the main ejection nozzle and the auxiliary ejection nozzle in a direction in which they separate away from the center of the lens yet maintaining constant a gap between these two nozzles;

discontinuing the ejection of the coating solution from the main ejection nozzle and the auxiliary ejection nozzle at the time when the main ejection nozzle is positioned on the edge of the plastic lens; and

drying a coating layer formed on the convex surface of the plastic lens.

In the method of the present invention, it is desired that:

(1) The coating solution is ejected while moving the main ejection nozzle and the auxiliary ejection nozzle along a straight line connecting the nozzle ports of the two nozzles;
(2) The main ejection nozzle and the auxiliary ejection nozzle have the same ejection port diameter, and the amount of ejecting the coating solution from the main ejection nozzle and the amount of ejecting the coating solution from the auxiliary ejection nozzle are adjusted to be the same;
(3) A gap d between the main ejection nozzle and the auxiliary ejection nozzle is set to lie in a range of 5 to 20 mm, and the coating solution is ejected while maintaining the above gap;
(4) The plastic lens has a diameter of 50 to 90 mm, and the coating solution is ejected while rotating the lens at a rotational speed of 30 to 300 rpm, moving the main ejection nozzle and the auxiliary ejection nozzle at a speed of 1.0 to 10.0 mm/second, and ejecting the coating solution from the main ejection nozzle and the auxiliary ejection nozzle in an amount of 0.03 to 0.25 g/second, respectively;
(5) The coating solution has a viscosity at 25° C. in a range of 1 to 100 cP;
(6) A primer coating film is formed by using, as the coating solution, a primer solution for a photochromic coating film; and
(7) A primer coating film having a thickness of 1.0 to 20.0 μm is formed.

### EFFECT OF THE INVENTION

The mechanism of development of stripes has not yet been clarified. From the fact that stripes develop when a coating solution containing an organic solvent of a low boiling point (i.e., organic solvent that easily dries) is used and that stripes develop conspicuously on a surface having a large degree of convexity, however, the present inventors presume as described below.

That is, when the coating solution is ejected onto the revolving substrate, the coating solution flows toward the circumferential edge of the substrate while rotating due to the centrifugal force and, therefore, a coating layer can be formed over the whole surface of the substrate. When the surface of the substrate is a convex surface, however, part of the coating solution that is ejected often flows down toward the circumferential edge from the central portion (i.e., flows linearly from the center of the convex surface in the radial direction of the convex surface). When the coating solution flows down as described above, it is presumed that the liquid that has flown down locally dries at the edge portions since the liquid flows fast at the circumferential edge, and marks left after drying are observed as stripes. This is because, when the substrate has a flat surface, the coating solution does not at all flow down. Further, when the convex surface is steeply curved (has a large degree of convexity), the coating solution easily flows down. Besides, the coating solution containing a low-boiling organic solvent easily dries as described above.

Thick stripes are observed near the edge of the lens probably because the centrifugal force increases toward the edge of the lens, the coating solution is little fed again onto the solution that has flown down and the solution easily dries up.

The development of stripes attributable to the flow down of the coating solution and the local drying can be avoided by ejecting the coating solution in large amounts. That is, when the coating solution is fed in large amounts, the amount of the coating solution is so large that local drying takes place little. However, use of the coating solution in large amounts results in an increase in the amount of the solution that flows out from the convex surface of the lens without being held on the convex surface. Therefore, a serious problem arises particularly when it is not allowed to use the coating solution again.

According to the present invention, on the other hand, use is made of the main ejection nozzle and the auxiliary nozzle maintaining a predetermined gap, the main ejection nozzle being positioned on the center of rotation of the plastic lens, and the coating solution is ejected while linearly moving the above nozzles maintaining constant the gap between the nozzles, making it possible to decrease the total amount of the coating solution that is used and to effectively prevent the development of stripes at the edge portion of the lens (convex surface). That is, in case the coating solution ejected from the main ejection nozzle has partly flown down, the coating solution is ejected from the auxiliary nozzle onto the circumferential edge where the solution is likely to be locally dried (dried at edge portions). Namely, the coating solution is fed from the auxiliary ejection nozzle onto the solution that has flown down suppressing the solution that has flown down from being locally dried. Further, the solution ejected to the circumferential edge from the auxiliary ejection nozzle nearly entirely flows down uniformly (the coating solution that is ejected almost all flows in the radial direction) since the centrifugal force is large at the circumferential edge, suppressing the local drying from taking place. By using the main ejection nozzle and the auxiliary nozzle as described above, the coating solution is ejected while moving the two nozzles linearly and in parallel making it possible to effectively prevent the development of stripes stemming from the local drying of the solution that has flown down at the circumferential edge of the lens, without ejecting the coating solution in increased amounts (without ejecting from the two nozzles in increased amounts). For example, when the coating is formed by ejecting the coating solution by using a single nozzle while moving the nozzle, the coating solution must be used in an amount of about three times or more to prevent the development of stripes as compared to when two nozzles are used as demonstrated in Examples appearing later.

The present invention employs a very simple means of ejecting the coating solution while linearly moving the main ejection nozzle and the auxiliary nozzle maintaining constant the gap therebetween. Therefore, the control operation is very easy without using complex programs of expensive control devices, and the invention can be put into practice very easily.

According to the method of the present invention, further, particularly distinguished effect is exhibited when there is used a coating solution having a viscosity that is adjusted to be 1 to 100 cP at 25° C. That is, the above coating solution has a high fluidity, flows down easily and, besides, usually, contains low-boiling organic solvent in large amounts, dries easily and, therefore, develops stripes to a conspicuous degree. The present invention makes it possible to effectively prevent the development of stripes even when the coating solution having the above viscosity is used.

The method of the present invention is capable of preventing the development of stripes despite of using the coating solution in a decreased amount, and is very effective in forming a primer layer for a photochromic coating film and, particularly, for forming a moisture-curing primer layer using a coating solution which cannot be reused even if used in excess amounts. Further, the primer solution used as a coating solution for forming the primer layer contains a volatile organic solvent and has, in many cases, a viscosity as described above and develops stripes to a conspicuous degree. The present invention, however, effectively prevents the development of stripes even when the coating solution is used for forming the primer layer, which is the greatest advantage of the invention.

### BRIEF DESCRIPTION OF THE DRAWINGS

FIG. 1 is a schematic view illustrating the positions of a main ejection nozzle and an auxiliary ejection nozzle at the start of ejecting a coating solution.

FIG. 2 is a schematic view illustrating the positions of the main ejection nozzle and the auxiliary ejection nozzle at the end of ejecting the coating solution in putting the method of the invention into practice.

FIG. 3 is a schematic view illustrating the direction in which the main ejection nozzle and the auxiliary ejection nozzle move in putting the method of the invention into practice.

FIG. 4 is a schematic view illustrating stripes that have developed in the coating film.

### BEST MODE FOR CARRYING OUT THE INVENTION

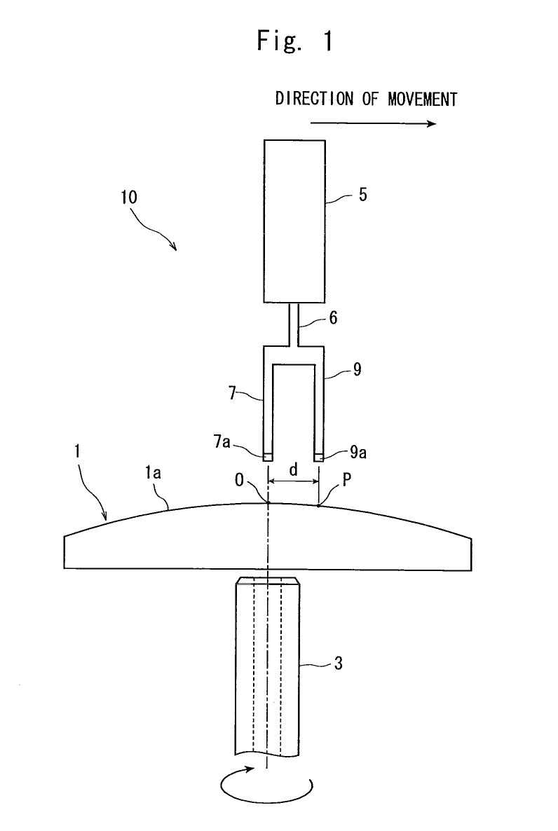

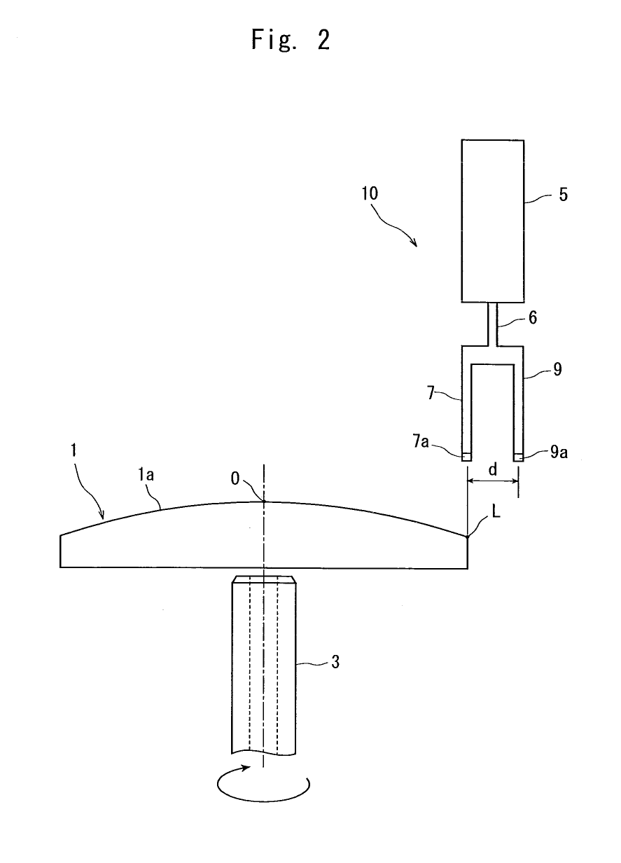

Referring to FIGS. 1 and 2, the method of the present invention is to form a coating film on a convex surface 1a of a plastic lens 1 by spin-coating and, in which a coating solution is ejected while rotating the plastic lens and moving an ejection device generally designated at 10, to form a coating layer of the coating solution on the whole convex surface 1a, followed by drying to thereby form a desired coating film.

### <Plastic Lens 1>

In the invention, the plastic lens 1 on which the coating film is to be formed has the shape of a disk as a whole and its surface is a convex surface 1a. In the invention, the degree of convexity of the convex surface 1a is not smaller than 1.0 and, particularly, not smaller than 3.0.

The degree of convexity is expressed by the following formula,

Degree of complexity=100 (cm)/focal distance (cm)

and, as will be understood from an inverse number of the focal distance, the unit of the degree of convexity is in diopters. That is, the larger this value, the larger the degree of curve of the surface (the smaller the radius of curvature as viewed from the side surface). That is, when the convex surface 1a of the plastic lens 1 is to be coated with the coating solution by spin-coating, the coating solution tends to easily flow down. Due to the flowing down, stripes easily develop at the circumferential edge portion of the lens 1, and the present invention must be applied. If the surface of the lens 1 is flat or the surface has a degree of convexity smaller than the above range, the coating solution does not flow down, and the present invention does not have to be applied.

Though there is no particular limitation, the upper limit of the convexity degree of the convex surface 1a of the plastic lens 1 to which the present invention is applied is, usually, about 14.0. That is, plastic lenses seldom have degrees of convexity in excess of 14.0 and, therefore, there is no need of giving consideration to a convex curve 1a having a degree of convexity in excess of 14.0.

Further, the plastic lens 1 has a diameter, usually, in a range of 50 to 90 mm.

There is no limitation on the material of the plastic lens 1 so far as it exhibits required optical properties. Generally, however, there can be exemplified (meth) acrylic resin, allyl resin, polyethylene terephthalate, polypropylene, polyethylene, polystyrene, polyurethane resin, thiourethane resin, epoxy resin, thioepoxy resin, polyvinyl chloride, polycarbonate resin and silicone resin. For the use of spectacle lenses, in particular, there can be preferably used (meth)acrylic resin, allyl resin, polyurethane resin, thiourethane resin, epoxy resin, thioepoxy resin and polycarbonate resin.

The plastic lens 1 has its back surface placed on a rotary shaft 3 that has a suction port at the center thereof, and is so held as to rotate in synchronism with the rotation of the rotary shaft 3 while being sucked by the rotary shaft 3.

### <Coating Solution>

In the invention, the coating solution used for forming a coating film on the convex surface 1a of the plastic lens 1 contains at least a volatile organic solvent. That is, the coating solution contains such an organic solvent and easily dries at the circumferential edge of the lens 1 while the coating solution is being ejected. Particularly, therefore, stripes develop as the coating solution that has flown down dries up locally. Therefore, the method of the invention is applied.

In the present invention, the volatile organic solvent is a low-boiling organic solvent having a boiling point which is lower than 100° C., such as ethyl acetate, methyl acetate, isopropyl acetate, methyl propionate, ethyl propionate, hexane, heptane, pentane, acetone, methyl ethyl ketone, diethyl ether, dipropyl ether, diisopropyl ether, benzene and tetrahydrofuran. It needs not be pointed out that the coating solution used in the present invention may further contain, in addition to the above low-boiling organic solvent, a high-boiling organic solvent having a boiling point of not lower than 100° C. as represented by an aromatic hydrocarbon, such as toluene or xylene, as a matter of course.

The coating solution used in the invention has a viscosity at 25° C. in a range of 1 to 100 cP, more preferably, 1 to 50 cP and, most preferably, 1 to 30 cP. The coating solution having the above viscosity has a high fluidity and is advantageous for being ejected from the ejection device 10 for forming a coating. Because of its high fluidity, however, the coating solution easily flows down on the convex surface 1a of the lens 1 and, therefore, easily develop stripes at the circumferential edge of the lens 1. Here, the present invention exhibits its advantage most effectively in preventing the development of stripes.

A concrete example of the coating solution containing the above volatile organic solvent is a primer solution (particularly, of the moisture-curing type). The primer solution is used for forming a primer coating film for improving the adhesion between the photochromic film that develops a color upon being irradiated with light and the plastic lens 1. The primer solution contains a polymer that highly adheres to the plastic lens 1 and to the photochromic film, or a prepolymer component capable of forming the polymer upon heating after a coating thereof has been formed, and much contains the above-mentioned volatile organic solvent and has a viscosity that, in many cases, lies in the above-mentioned range. Further, the primer coating film, usually, has a thickness in a range of 1.0 to 20.0 μm and develops stripes conspicuously. The present invention, however, makes it possible to prevent the development of stripes despite of ejecting the coating solution in a decreased amount. Therefore, the present invention is effective in forming a particularly thin primer coating film.

A representative example of the primer solution contains a polymer or a prepolymer solid component in an amount of 10 to 50% by mass and a low-boiling solvent having a boiling point of lower than 100° C. in an amount of 20 to 90% by mass, further contains, as required, a high-boiling solvent having a boiling point of not lower than 100° C. in an amount not more than 70% by mass, is, further, often blended with a leveling agent such as surfactant and has a viscosity (25° C.) adjusted to lie in the above-mentioned range. The most preferred primer solution contains a prepolymer of a moisture-curing polyurethane resin as disclosed in, for example, JP-A-2005-199683 in an amount of 15 to 40% by mass, a low-boiling solvent such as ethyl acetate in an amount of 30 to 85% by mass, further contains a high-boiling solvent such as toluene in an amount of not more than 55% by weight, is blended with a suitable leveling agent and has a viscosity that is adjusted to lie in the above-mentioned range. That is, the above primer solution is applied onto the convex surface 1a of the plastic lens 1 by spin-coating according to the method of the invention, and the formed coating layer is dried and cured at normal temperature to form the primer coating film having the above-mentioned thickness.

### <Ejection Device 10>

Referring to FIGS. 1 and 2, the ejection device 10 used in the embodiment of the invention has a valve 5 to which a nozzle 6 of an integral type is connected. The integral type nozzle 6 has a main ejection nozzle 7 and an auxiliary nozzle 9, and a gap d is maintained between a nozzle port 7a of the main ejection nozzle 7 and a nozzle port 9a of the auxiliary nozzle 9.

Further, though no shown, solution feed means such as a pressurized tank is connected to the valve 5. A pressure is exerted on the pressurized tank by using an inert gas such as nitrogen and, at the same time, the valve 5 is opened to feed the coating solution contained in the pressurized tank to the valve 5 so as to flow through the valve 5 and the nozzle 6, and is fed to the main ejection nozzle 7 and to the auxiliary nozzle 9. In the above ejection device 10, the valve 5 is held by a moving arm and a rail (not shown) so as to be linearly moved. Accompanying the movement of the valve 5, the main ejection nozzle 7 and the auxiliary ejection nozzle 9 integrally move maintaining the gap d.

It is also allowable to provide the main ejection nozzle 7 and the auxiliary ejection nozzle 9 separately from each other, connect them to separate valves (or separate pressurized tanks) and to independently move them. By taking the adjustment of the ejection amount or controlling the movements of the two nozzles into consideration, however, it is desired that the two nozzles are connected to the same valve 5.

### <Ejecting (Coating) the Coating Solution>

The coating solution is ejected by using the above ejection device 10. Namely, as shown in FIG. 1, the main nozzle 7 is positioned on the center line O of the plastic lens 1. In this state, the plastic lens 1 is rotated at a constant speed, the coating solution is ejected from the main ejection nozzle 7 and the auxiliary nozzle 9 while linearly moving the ejection device 10. The ejection of the coating solution is discontinued when the main ejection nozzle 7 has arrived at the edge L of the lens 1 as shown in FIG. 2. That is, the coating solution ejected from the auxiliary ejection nozzle 9 forms a coating on the portion (circumferential edge) on the outer side of a position designated at P on the convex surface 1a of the lens 1 and, thereafter, the solution ejected from the main ejection nozzle 7 forms a coating on the circumferential edge after a predetermined timing.

According to the present invention as described above, the coating solution is ejected while moving the ejection device 10 as described above. Here, since the gap d is maintained constant between the nozzle port 7a of the main ejection nozzle 7 and the nozzle port 9a of the auxiliary ejection nozzle 9, the coating solution ejected from the main ejection nozzle 7 onto the central portion of the lens 1 linearly flows down toward the circumferential edge and, besides, the solution ejected from the auxiliary ejection nozzle 9 is fed onto the solution that is flowing down effectively suppressing the solution that is flowing down from being locally dried at the circumferential edge of the lens 1. As a result, development of stripes is effectively prevented by using the coating solution in a small amount without the need of using the coating solution in unnecessarily large amounts.

The timing for discontinuing the ejection of the coating solution does not strictly have to be a moment at which the main ejection nozzle 7 has arrived at the edge L of the lens 1. If the ejection is discontinued after having passed over the edge L, however, the amount of the coating solution wastefully increases. If the ejection is discontinued before arriving at the edge L, on the other hand, stripes may often develop near the edge L of the lens. It is, therefore, necessary to discontinue the ejection of the coating solution maintaining a certain degree of precision. For example, the ejection of the coating solution may be discontinued at a moment when the nozzle port 7a of the main ejection nozzle 7 has arrived at a position of about ±3 mm with respect to the straight line passing the edge L of the lens 1.

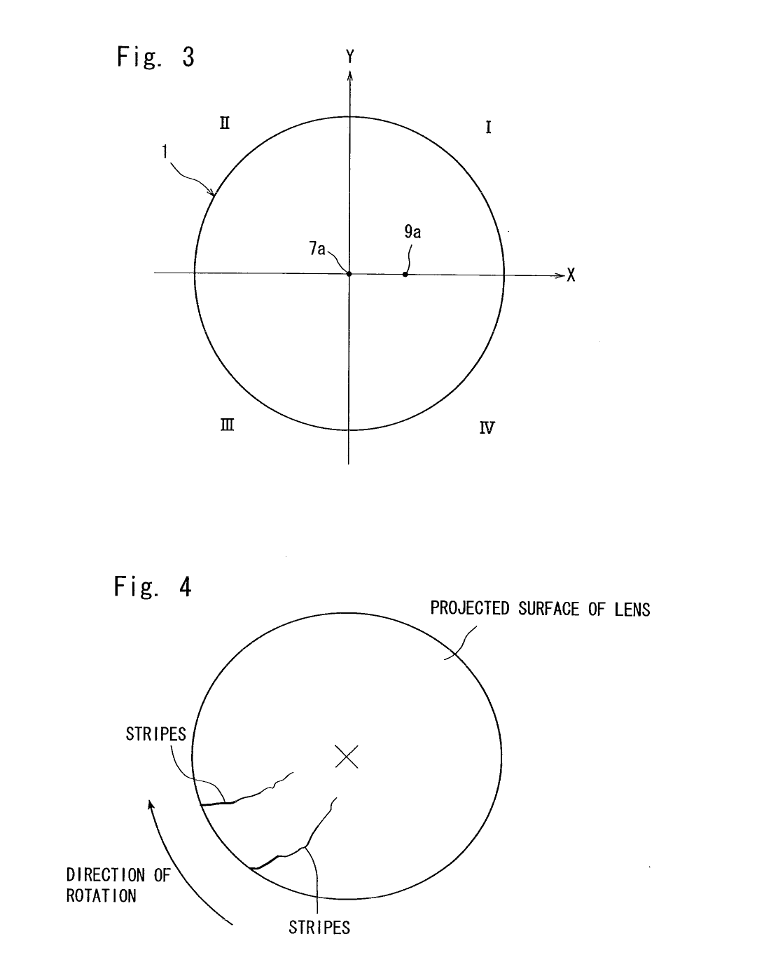

The direction in which the ejection device 10 (main ejection nozzle 7 and auxiliary ejection nozzle 9) moves may be a direction in which both the nozzle ports 7a and 9a move away from the center O of the lens under a condition where the nozzle ports 7a and 9a move linearly maintaining the gap d which is constant. Concretely as shown in FIG. 3 illustrating axes of coordinates (X, Y) in which a straight line connecting the nozzle port 7a positioned on the center O of the lens 1 to the nozzle port 9a positioned on a circumferential portion P is regarded to be the X-axis, there is no limitation on the direction of movement if it lies on the regions of first and fourth quadrants. In this case, if moved in a direction maintaining a predetermined angle relative to the straight line (axis X) that connects the nozzle port 7a to the nozzle port 9a positioned on the circumferential edge portion P, then the time can be lengthened in which the nozzle port 9a of the auxiliary ejection nozzle 9 ejects the coating solution onto the surface of the lens 1 making it possible to effectively use the coating solution and to decrease the amount of the coating solution that is used. In the present invention, however, it is desired to move the ejection device 10 along the above straight line (axis X). This is because the direction of movement can be easily set, error in the direction of movement can be decreased with respect to many lenses 1, and the ejection can be effected in the same direction of movement.

It is, further, desired that the ejection of the coating solution from the auxiliary ejection nozzle 9 is discontinued at a moment when the nozzle 9 has arrived at the edge L of the lens 1 from the standpoint of not wasting the coating solution. In this case, however, a control mechanism is necessary for selectively discontinuing the ejection of the coating solution from the auxiliary ejection nozzle 9 only separately from the main ejection nozzle 7, and it becomes complex to control the amount of ejection. Therefore, the ejection of the coating solution from the main ejection nozzle 7 and the auxiliary ejection nozzle 9 should be discontinued simultaneously at a moment when the main ejection nozzle 7 has arrived at the edge L of the lens 1.

As briefly described above, further, the main ejection nozzle 7 and the auxiliary ejection nozzle 9 can be connected to separate valves 5 and can, therefore, be moved independent of each other. In this case, too, however, the main ejection nozzle 7 and the auxiliary ejection nozzle 9 must be moved while maintaining constant the gap d between the nozzle port 7a and the nozzle port 9a. If the gap d varies, the time varies until the coating solution from the main ejection nozzle 7 arrives at the region to where the coating solution has been fed from the auxiliary ejection nozzle 7. As a result, it becomes difficult to effectively prevent the local drying of the coating solution that has flown down to the circumferential edge, and the effect for preventing the development of stripes varies.

In the present invention, the coating solution is ejected from the main ejection nozzle 7 and the auxiliary ejection nozzle 9 to form a coating as described above. Here, the main ejection nozzle 7 and the auxiliary ejection nozzle 9 have the same ejection port diameter (inner diameter), and it is desired that the amount of ejecting the coating solution from the main ejection nozzle 7 is adjusted to be the same as the amount of ejecting the coating solution from the auxiliary ejection nozzle 9. That is, by using the main ejection nozzle 7 and the auxiliary ejection nozzle 9 having the same port diameter, the amounts of the coating solution ejected from the two nozzles can be easily adjusted to be equal. Upon adjusting the amounts of ejection to be equal, further, the coating solution can be fed from the main ejection nozzle 7 to the circumferential edge of the lens 1 in an amount equal to the amount of the coating solution fed thereto from the auxiliary ejection nozzle 9 but after a constant time lag at all times. This reliably prevents the local drying of the coating solution at the circumferential edge and stably suppresses the development of stripes.

In the present invention, further, it is desired that the gap d between the main ejection nozzle 7 and the auxiliary ejection nozzle 9 (gap between the central perpendicular of the nozzle port 7a and the central perpendicular of 9a) is set to lie in a range of 5 to 20 mm. If the gap d is short, there is no change from the case when the coating solution is ejected from the single nozzle to form a coating and it becomes necessary to use the coating solution in large amounts to prevent the development of stripes. If the gap d is too long, on the other hand, the time becomes too long from when the coating is formed by the auxiliary ejection nozzle 9 until when the coating is formed by the main ejection nozzle 7. As a result, the coating solution that has flown down to the circumferential edge tends to be locally dried, and the effect for preventing the development of stripes decreases.

In forming the coating as described above, the rotational speed of the lens 1, moving speed of the ejection device 10 (nozzle port 7a of the main ejection nozzle 7 and nozzle port 9a of the auxiliary ejection nozzle 9) and amounts of ejecting the coating solution from the main ejection nozzle 7 and the auxiliary ejection nozzle 9, are suitably set depending upon the gap d, viscosity of the coating solution and the size and the degree of convexity of the lens 1. Generally, however, taking an example of coating the convex surface 1a of the plastic lens 1 having a diameter of 50 to 90 mm, it is desired to eject the coating solution under the conditions where the lens 1 rotates at a speed of 30 to 300 rpm, particularly, 50 to 200 rpm, the main ejection nozzle 7 and the auxiliary ejection nozzle 9 move at a speed of 1.0 to 10.0 mm/sec, 2.0 to 5.0 mm/s, and the coating solution is ejected from the main ejection nozzle 7 and the auxiliary ejection nozzle 9, respectively, in an amount of 0.03 to 0.25 g/sec, particularly, 0.04 to 0.2 g/sec and, most desirably, 0.05 to 0.15 g/sec. When the coating is formed under the above conditions, the development of stripes can be prevented with the amount of the coating solution from the nozzles being less than about 2 g as demonstrated in Examples appearing later. Here, if a single nozzle is moved under the same conditions as above, then the coating solution is used in an amount of 6 g to prevent the development of stripes, which is about three times as great.

When the coating is formed as described above, there is no particular limitation on the height of nozzle port 7a of the main ejection nozzle 7 (distance from the convex surface 1a of the lens 1) or on the height of nozzle port 9a of the auxiliary ejection nozzle 9. Generally, however, it is desired that the height is set in a range of 1 to 20 mm. That is, if the gap between the nozzle ports and the convex surface 1a is too small, the coating solution that is ejected tends to be diffused. If the gap is too large, the coating solution tends to be dried while being ejected. In this case, the nozzles 7 to 9 may be moved while varying the heights of the nozzle ports 7a and 9a depending upon the convex surface 1a. From the standpoint of easy control, however, it is desired that the nozzles 7 and 9 are moved while maintaining the initial height.

### <Drying>

In the present invention, the coating is formed as described above and is, thereafter, dried to form a desired coating film. The coating may be dried naturally or by being heated at a temperature to a degree that does not cause the plastic lens 1 to be deformed.

Depending upon the kind of coating film, further, the curing by polymerization may be effected by being suitably heated or irradiated with ultraviolet rays simultaneously with the drying, as a matter of course.

When the primer coating film is formed by the above method, further, a photochromic coating film can be laminated thereon and, besides, a hard coating can be formed thereon by the similar method.

### EXAMPLES

The invention will now be described based on Experiments.

Described below are the plastic lenses and primers used in the Experiments.

### [Plastic Lenses]

CR: Allyl resin plastic lens, refractive index=1.50
MRA: Thiourethane resin plastic lens, refractive index=1.60
MRB: Thiourethane resin plastic lens, refractive index=1.67
TE: Thioepoxy resin plastic lens, refractive index=1.71
SPL: Methacrylic resin plastic lens, refractive index=1.54
SE: Methacrylic resin+vinyl resin lens, refractive index=1.60

### {Primers}

P1: Takeseal PFR402TP-4 (moisture-curing type primer, manufactured by Takebayashi Kagaku Kogyo Co.)
solid component/toluene/ethyl acetate=26/26/48 (wt %)
P2: Takeseal PFR4 (moisture-curing type primer, manufactured by Takebayashi Kagaku Kogyo Co.)
solid component/toluene=50/50 (wt %)
P3: Urethane Primer 06 (moisture-curing type primer, manufactured by Alps Kagaku Co.)
solid component/toluene/ethyl acetate=1.5/75-85/5-15 (wt %)
P4: Takenate M-402P (moisture-curing type primer, manufactured by Mitsui-Takeda Chemical Co.)
solid component/toluene/ethyl acetate/xylene/propylene glycol monomethyl ether acetate=25/45/10-15/8/4/5-10 (wt %)
P5: Barnock DM652 (moisture-curing type primer, manufactured by Dainihon Ink Kagaku Kogyo Co.)

### <Preparation of Primer Solutions>

By using the above primers, the following primer solutions A to G of the following recipes were prepared as coating solutions. The viscosities were those at 25° C.

Primer solution A (viscosity, 5 cP);
Primer P1: 50 mass parts
Ethyl acetate: 50 mass parts
Leveling agent (FZ-2104, manufactured by Toray-Dow Coning Co.): 0.03 mass parts

Primer solution B (viscosity, 6 cP);
Primer P1: 70 mass parts
Ethyl acetate: 30 mass parts
Leveling agent (FZ-2104, manufactured by Toray-Dow Coning Co.): 0.015 mass parts

Primer solution C (viscosity, 5 cP);
Primer P1: 60 mass parts
Ethyl acetate: 15 mass parts
Butyl acetate: 15 mass parts
Leveling agent (surfactant, L-7001, manufactured by Toray-Dow Coning Co.): 0.03 mass parts

Primer solution D (viscosity, 4 cP);
Primer P2: 80 mass parts
Ethyl acetate: 20 mass parts
Leveling agent (surfactant, L-7001, manufactured by Toray-Dow Coning Co.): 0.03 mass parts

Primer solution E (viscosity, 15 cP);
Primer P4: 50 mass parts
Ethyl acetate: 50 mass parts
Leveling agent (FZ-2104, manufactured by Toray-Dow Coning Co.): 0.03 mass parts

Primer solution F (viscosity, 20 cP);
Primer P5: 75 mass parts
Ethyl acetate: 25 mass parts
Leveling agent (FZ-2104, manufactured by Toray-Dow Coning Co.): 0.03 mass parts

Primer solution G (viscosity, 2 cP);
Primer P3: 80 mass parts
Ethyl acetate: 20 mass parts
Leveling agent (surfactant, L-7001, manufactured by Toray-Dow Coning Co.): 0.03 mass parts

The coating films formed by the following Experiments were evaluated for their appearances by a method described below.

A plastic lens having a coating film (primer layer) formed thereon was irradiated with light from a high-pressure mercury lamp and was projected onto a white paper (see FIG. 4). The projected surface of the plastic lens as a whole was observed and evaluated; i.e., the number of stripes that could be observed by eyes and maximum lengths of the stripes were confirmed. The evaluation was on the following basis:
⊚: No stripe developed.
◯: A stripe developed and its length was 1 mm to 5 mm or shorter.
Δ: A plurality of stripes developed and their maximum lengths were 1 mm to 5 mm or shorter.
X: A plurality of stripes developed and their maximum lengths exceeded 5 mm.

### Experiment 1

The CR having a degree of convexity of 6.0 and a diameter of 70 mm was provided as a plastic lens, and the primer solution A prepared above was provided as a coating solution.

The above plastic lens was dewaxed with acetone to a sufficient degree, treated with an aqueous solution containing 5% of sodium hydroxide maintained at 50° C. for 4 minutes, washed with flushing water for 4 minutes, washed with distilled water maintained at 40° C. for 4 minutes and was, thereafter, dried at 70° C.

Next, by using the ejection device 10 shown in FIGS. 1 and 2, the convex surface of the above plastic lens was coated with the primer solution A under the conditions shown in Table 1.

The nozzle port 7a of the main ejection nozzle 7 and the nozzle port 9a of the auxiliary ejection nozzle 9 were presumed to be on the same plane, and the distance between the nozzle port 7a and the center O of the plastic lens 1 was set to be 5 mm. The amounts of the primer solution ejected from the main ejection nozzle 7 and from the auxiliary ejection nozzle 9 were set to be the same (one-half the total amount (g/sec) ejected from the main ejection nozzle and the auxiliary ejection nozzle in Table 1 is the amount ejected from each nozzle). The primer solution was ejected from the auxiliary ejection nozzle 9 in the same amount until the main ejection nozzle 7 moved to the upper part of the circumferential edge.

The thus coated layer was cured at room temperature for 15 minutes to thereby obtain a primer coating film. The obtained primer coating film was evaluated for its appearance (development of stripes) to obtain results as shown in Table 1.

### Experiments 2 to 13

Primer coating films were formed in the same manner as in Experiment 1 but using the primer solutions B to G, using plastic lenses of sizes shown in Table 1, using the ejection device having two nozzles and varying the coating conditions as shown in Table 1. The primer coating films were evaluated for their appearance to obtain results as shown in Table 1.

### Examples 14 and 15

Primer coating films were formed in the same manner as in Experiment 1 but using the lenses and primer solutions shown in Table 1, and using the ejection device provided with the main ejection nozzle only under the conditions as shown in Table 1. The primer coating films were evaluated to obtain results as shown in Table 1.

In these Experiments, the coating conditions shown in Table 1 were concerned to the inner diameter of the main ejection nozzle, moving speed of the main ejection nozzle and the amount of ejection from the main ejection nozzle. The primer layers were formed under these conditions and were evaluated for their appearance in the same manner as in Experiment 1. The results were as shown in Table 1.

TABLE 1

| | Experiment No. | | | | | | | |
|---|---|---|---|---|---|---|---|---|
| | 1 | 2 | 3 | 4 | 5 | 6 | 7 | 8 |
| Lens | | | | | | | | |
| Kind of lens | CR | CR | CR | CR | MRA | CR | MRB | TE |
| Deg. of convexity | 6.0 | 4.5 | 11.0 | 14.0 | 4.0 | 7.0 | 9.0 | 6.0 |
| Lens diameter (mm) | 70 | 75 | 65 | 65 | 75 | 65 | 65 | 65 |
| Primer solution | A | A | A | A | A | B | C | D |
| Coating conditions | | | | | | | | |
| Rotational speed of lens (rpm) | 70 | 70 | 120 | 120 | 120 | 70 | 70 | 70 |
| Number of ejection nozzles | 2 | 2 | 2 | 2 | 2 | 2 | 2 | 2 |
| Gap d between ejection ports 7a and 7b (mm) | 15 | 15 | 15 | 15 | 10 | 5 | 10 | 20 |
| Inner diameter of ejection ports 7a, 7b (mm) | 0.58 | 0.58 | 0.58 | 0.58 | 0.58 | 0.49 | 0.68 | 0.58 |
| Moving speed of nozzles (mm/s) | 3.5 | 3.5 | 3.5 | 3.5 | 3.5 | 3.5 | 3.5 | 3.0 |
| Total ejection amount from nozzles 7, 9 (g/s) | 0.15 | 0.15 | 0.2 | 0.2 | 0.18 | 0.2 | 0.22 | 0.25 |
| Total amount of primer sol. used (g) | 1.50 | 1.61 | 1.86 | 1.86 | 1.93 | 1.86 | 2.04 | 2.71 |
| Appearance | | | | | | | | |
| Overall evaluation | ⊚ | ⊚ | ⊚ | ⊚ | ⊚ | ⊚ | ⊚ | ⊚ |
| Number of stripes | 0 | 0 | 0 | 0 | 0 | 0 | 0 | 0 |
| Max. length of stripe (mm) | — | — | — | — | — | — | — | — |

| | Experiment No. | | | | | | |
|---|---|---|---|---|---|---|---|
| | 9 | 10 | 11 | 12 | 13 | 14 | 15 |
| Lens | | | | | | | |
| Kind of lens | SE | SPL | MRB | CR | CR | CR | CR |
| Deg. of convexity | 11.0 | 12.0 | 4.0 | 6.0 | 6.0 | 6.0 | 6.0 |
| Lens diameter (mm) | 65 | 65 | 75 | 70 | 70 | 70 | 70 |
| Primer solution | E | F | G | A | A | A | A |
| Coating conditions | | | | | | | |
| Rotational speed of lens (rpm) | 70 | 100 | 70 | 70 | 70 | 70 | 70 |
| Number of ejection nozzles | 2 | 2 | 2 | 2 | 2 | 1 | 1 |
| Gap d between ejection ports 7a and 7b (mm) | 15 | 10 | 10 | 3 | 25 | — | — |
| Inner diameter of ejection ports 7a, 7b (mm) | 0.58 | 0.68 | 0.58 | 0.58 | 0.58 | 0.58 | 0.58 |
| Moving speed of nozzles (mm/s) | 3.5 | 4.0 | 3.5 | 3.5 | 3.5 | 3.5 | 3.5 |
| Total ejection amount from nozzles 7, 9 (g/s) | 0.22 | 0.23 | 0.13 | 0.15 | 0.15 | 0.15 | 0.6 |
| Total amount of primer sol. used (g) | 2.04 | 1.87 | 1.39 | 1.50 | 1.50 | 1.50 | 6.00 |
| Appearance | | | | | | | |
| Overall evaluation | ⊚ | ⊚ | ⊚ | ◯ | ◯ | X | ⊚ |
| Number of stripes | 0 | 0 | 0 | 1 | 1 | 2 | 0 |
| Max. length of stripe (mm) | — | — | — | 3 | 4 | 7 | — |

* In Experiments 14 and 15, the inner diameter of nozzle ejection port, moving speed and total ejection amount were those values of the main ejection nozzle.

As will be obvious from the results of above Table 1, upon providing the main ejection nozzle and the auxiliary ejection nozzle and upon forming the coating while moving these nozzles, it is made possible to form the coating film without developing stripes by using the coating solution in small amounts.

1. A method of forming a coating film on a convex surface of a plastic lens having the convex surface of a degree of convexity defined by the following formula,
degree of convexity=100 (cm)/focal distance (cm)
of not smaller than 1.0, including:
using an ejection device having a main ejection nozzle and an auxiliary ejection nozzle;
arranging the main ejection nozzle and the auxiliary nozzle over the convex surface of said plastic lens in a manner that the main ejection nozzle is positioned over a center of said plastic lens;
ejecting a coating solution containing a volatile organic solvent having a boiling point of lower than 100° C. from the main ejection nozzle and the auxiliary ejection nozzle, simultaneously, in a state where said plastic lens is maintained rotated, while linearly moving the main ejection nozzle and the auxiliary ejection nozzle in a direction in which they separate away from the center of the lens yet maintaining constant a gap between these two nozzles;
discontinuing the ejection of said coating solution from said main ejection nozzle and said auxiliary ejection nozzle at the time when said main ejection nozzle is positioned on the edge of said plastic lens; and
drying a coating layer formed on the convex surface of said plastic lens.

2. The method of forming a coating film according to claim 1, wherein said coating solution is ejected while moving said main ejection nozzle and said auxiliary ejection nozzle along a straight line connecting the nozzle ports of the two nozzles.

3. The method of forming a coating film according to claim 1, wherein said main ejection nozzle and said auxiliary ejection nozzle have the same ejection port diameter, and the amount of ejecting the coating solution from the main ejection nozzle and the amount of ejecting the coating solution from the auxiliary ejection nozzle are adjusted to be the same.

4. The method of forming a coating film according to claim 2, wherein a gap d between said main ejection nozzle and said auxiliary ejection nozzle is set to lie in a range of 5 to 20 mm, and the coating solution is ejected while maintaining the above gap.

5. The method of forming a coating film according to claim 4, wherein said plastic lens has a diameter of 50 to 90 mm, and the coating solution is ejected while rotating the lens at a rotational speed of 30 to 300 rpm, moving said main ejection nozzle and said auxiliary ejection nozzle at a speed of 1.0 to 10.0 mm/second, and ejecting the coating solution from said main ejection nozzle and said auxiliary ejection nozzle in an amount of 0.03 to 0.25 g/second, respectively.

6. The method of forming a coating film according to claim 1, wherein said coating solution has a viscosity at 25° C. in a range of 1 to 100 cP.

7. The method of forming a coating film according to claim 1, wherein a primer coating film is formed by using, as said coating solution, a primer solution for a photochromic coating film.

8. The method of forming a coating film according to claim 7, wherein a primer coating film having a thickness of 1.0 to 20.0 μm is formed.
